(19) United States
(12) Patent Application Publication
(10) Pub. No.: US 2014/0170445 A1
(43) Pub. Date: Jun. 19, 2014

(54) POWER BATTERY COVER

(71) Applicant: Ningde Amperex Technology Limited, Ningde City (CN)

(72) Inventors: Quankun LI, Ningde City (CN); Pinghua DENG, Ningde City (CN); Peng WANG, Ningde City (CN); Kai WU, Ningde City (CN)

(73) Assignee: Ningde Amperex Technology Limited, Ningde City (CN)

(21) Appl. No.: 14/132,147

(22) Filed: Dec. 18, 2013

(30) Foreign Application Priority Data
Dec. 19, 2012 (CN) 201210552654.6

(51) Int. Cl. H01M 2/34; H01M 2/04

(52) U.S. Cl. CPC H01M 2/345; H01M 2/043
USPC 429/56

(57) ABSTRACT

A power battery cover, which comprises a cover plate, a burst vent, a first terminal, a second terminal and a conducting strip; wherein, the burst vent, the first terminal and the second terminal are arranged on the cover plate, the second terminal is electrically connected to the cover plate, and the first terminal is subject to an insulated assembly with the cover plate and is electrically connected to the conducting strip; the power battery cover also comprises a tensile shrapnel which is welded to the cover plate; the tensile shrapnel is arranged under and close to the conducting strip; under the condition of overcharge of a battery, air pressure in the battery cell rises due to decomposition of the electrolyte.

### FIELD OF THE INVENTION

The invention pertains to the technical field of a power battery, in particular to a power battery cover.

### BACKGROUND OF THE INVENTION

With development of modern society and strengthening of environmental protection consciousness, more and more devices can be equipped with selectable and rechargeable secondary batteries as a power supply, such as mobile phones, notebook computers, power tools, electric automobiles and so on, which provides broad space for application and development of rechargeable secondary batteries.

Electric automobiles and storage power stations generally need power batteries of large capacity as their power supplies. These power batteries are characterized by high power capacity, good safety and longer cycle life etc., so as to meet usage criteria and users' demands.

Under the condition of overcharge or extrusion of the power battery, in the power battery excess heat or internal pressure rises due to decomposition of the electrolyte; consequently, the power battery may breaks out a fire or an explosion. Compared with a cylindrical battery, a prismatic battery is difficult to have a structure capable of cutting off or releasing current in case of rise of heat and pressure.

### SUMMARY OF THE INVENTION

The aim of the invention is, in view of disadvantages of the prior art, to provide a power battery cover, which can cut off or release current in case of internal overheating and pressure build-up, thus solving the safety problem of an overcharged power battery and preventing the battery from outbreak of a fire or a burst.

In order to achieve the above-mentioned aim, the invention adopts such a technical scheme as below: a power battery cover, comprising a cover plate, a burst vent, a first terminal, a second terminal and a conducting strip; wherein, the burst vent, the first terminal and the second terminal are arranged on the cover plate, the second terminal is electrically connected to the cover plate, and the first terminal is subject to an insulated assembly with the cover plate and is electrically connected to the conducting strip; the power battery cover also comprises a tensile shrapnel which is welded to the cover plate; the tensile shrapnel is arranged under and close to the conducting strip.

The tensile shrapnel comprises a tensile top and a tensile lateral, and the tensile lateral is connected to the tensile top.

A section formed by the tensile top and the tensile lateral is shaped like an “n”, the free end of the tensile lateral is provided with a first extended part, and the first extended part is parallel to the tensile top.

The tensile lateral comprises a first arc and a second extended part, the first arc is set as an incurvate semi-circle, the second extended part is connected to the first arc, and the second extended part is parallel to the tensile top.

The tensile lateral comprises a second arc and a first L-shaped block, the second arc is set as an incurvate semi-circle, and the first L-shaped block is connected to the second arc.

The tensile lateral comprises a sunken concave part, a raised convex part and a second L-shaped block, the concave part is smoothly connected to the convex part, and the convex part is connected to the second L-shaped block.

The tensile top is shaped like a rectangle, a circle or an oval.

The invention has a beneficial effect in that: the invention comprises a cover plate, a burst vent, a first terminal, a second terminal and a conducting strip; wherein, both the first terminal and the second terminal are arranged on the cover plate, the second terminal is electrically connected to the cover plate, and the first terminal is subject to an insulated assembly with the cover plate and is electrically connected to the conducting strip; the power battery cover also comprises a tensile shrapnel which is welded to the cover plate; the tensile shrapnel is arranged under and close to the conducting strip; under the condition of overcharge of a battery, air pressure in the battery cell rises due to decomposition of the electrolyte, at this time the tensile shrapnel is lengthened and is conductive to the conducting strip, thus forming a return circuit for releasing current between the anode and the cathode of the battery, so as to guarantee the power battery is cut off when inside of the battery is subject to an overheating or pressure build-up, which solves the safety problem of an overcharged power battery and prevents the battery from outbreak of a fire or a burst.

### BRIEF DESCRIPTION OF THE DRAWINGS

FIG. 1 is a schematic view of the invention;

FIG. 2 is an enlarged view of A in FIG. 1 and a schematic view of Embodiment 1;

FIG. 3 is a schematic view of Embodiment 2 in the invention;

FIG. 4 is a schematic view of Embodiment 3 in the invention; and

FIG. 5 is a schematic view of Embodiment 4 in the invention.

### DETAILED DESCRIPTION OF THE EMBODIMENTS

Detailed description of the invention and the beneficial effect thereof is made in conjunction with the accompanying drawings and embodiments. However, the invention is not limited to the embodiments.

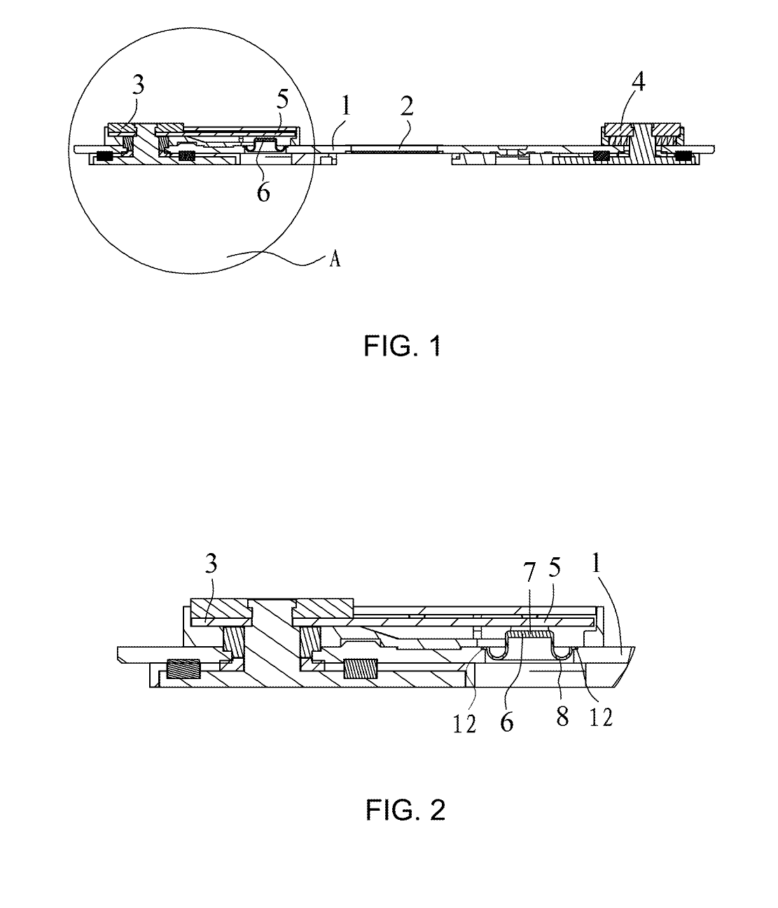

Embodiment 1, just shown as FIGS. 1 and 2, a power battery cover comprises a cover plate 1, a burst vent 2, a first terminal 3, a second terminal 4 and a conducting strip 5; wherein, the burst vent 2, the first terminal 3 and the second terminal 4 are arranged on the cover plate 1, the second terminal 4 is electrically connected to the cover plate 1, and the first terminal 3 is subject to an insulated assembly with the cover plate 1 and is electrically connected to the conducting strip 5; the power battery cover also comprises a tensile shrapnel 6 which is welded to the cover plate 1; the tensile shrapnel 6 is arranged under and close to the conducting strip 5;

Preferably, the tensile shrapnel 6 comprises a tensile top 7 and a tensile lateral 8, and the tensile lateral 8 is connected to the tensile top 7.

More preferably, a section formed by the tensile top 7 and the tensile lateral 8 is shaped like an “n”, the free end of the tensile lateral 8 is provided with a first extended part 12, and the first extended part 12 is parallel to the tensile top 7. The tensile top 7 shall be made as thick as possible, while the tensile lateral 8 shall be made as thin as possible, which is to the benefit of elongation under an authorised pressure and of increasing discharge capacity, thus preventing the tensile shrapnel from fusing due to overheating resulted from heavy current after the tensile shrapnel touches the conducting strip.

The tensile shrapnel 6 is made from aluminum or nickel, while the conducting strip 5 is made from copper, aluminum or nickel; and the surface of the conducting strip 5 is nickel plated or tin plated so as to reduce the contact resistance between the conducting strip 5 and the tensile shrapnel 6.

Preferably, the tensile top 7 is shaped like a rectangle, a circle or an oval.

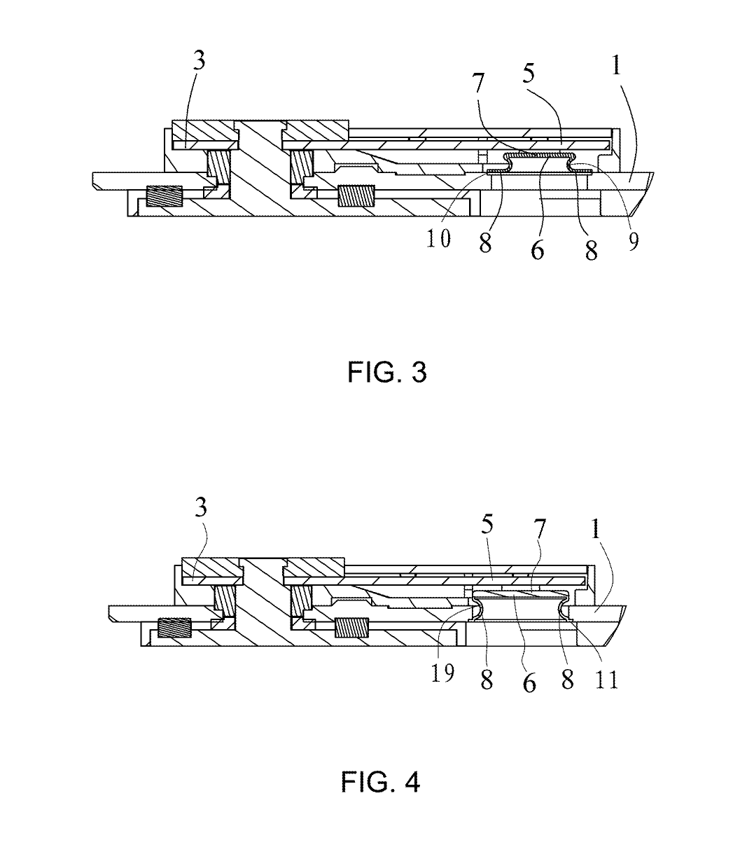

Embodiment 2, just shown as FIG. 3, is different from Embodiment 1 in that: the tensile lateral 8 comprises a first arc 9 and a second extended part 10, the first arc 9 is set as an incurvate semi-circle, the second extended part 10 is connected to the first arc 9, and the second extended part 10 is parallel to the tensile top 7.

The remaining steps are the same as described in Embodiment 1, not repeated here.

Embodiment 3, just shown as FIG. 4, is different from Embodiment 2 in that: the tensile lateral 8 comprises a second arc 19 and a first L-shaped block 11, the second arc 19 is set as an incurvate semi-circle, and the first L-shaped block 11 is connected to the second arc 19.

The remaining steps are the same as described in Embodiment 2, not repeated here.

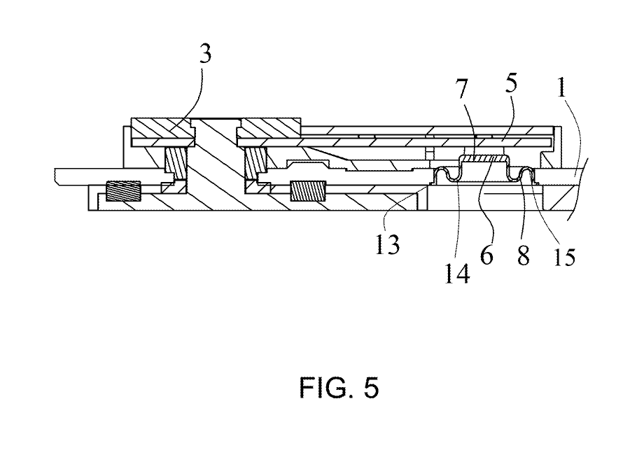

Embodiment 4, just shown as FIG. 5, is different from Embodiment 3 in that: the tensile lateral 8 comprises a sunken concave part 14, a raised convex part 15 and a second L-shaped block 13, the concave part 14 is smoothly connected to the convex part 15, and the convex part 15 is connected to the second L-shaped block 13.

The remaining steps are the same as described in Embodiment 2, not repeated here.

Those skilled in the art can, on the basis of disclosure and instruction of the specification above-mentioned, make a change or modification of the embodiments mentioned above. Therefore, the invention is not limited to the embodiments, and equivalent modification and change of the invention are within the scope of protection of claims of the invention. In addition, some specific terms are used in the specification for the convenience of description, but not to limit the invention.

What is claimed is:

1. A power battery cover, comprising a cover plate (1), a burst vent (2), a first terminal (3), a second terminal (4) and a conducting strip (5); wherein the burst vent (2), the first terminal (3) and the second terminal (4) are arranged on the cover plate (1), the second terminal (4) is electrically connected to the cover plate (1), and the first terminal (3) is subject to an insulated assembly with the cover plate (1) and is electrically connected to the conducting strip (5); the power battery cover also comprises a tensile shrapnel (6) which is welded to the cover plate (1);
the tensile shrapnel (6) is arranged under and close to the conducting strip (5).

2. The power battery cover of claim 1, wherein the tensile shrapnel (6) comprises a tensile top (7) and a tensile lateral (8), and the tensile lateral (8) is connected to the tensile top (7).

3. The power battery cover of claim 2, wherein a section formed by the tensile top (7) and the tensile lateral (8) is shaped like an “n”, the free end of the tensile lateral (8) is provided with a first extended part (12), and the first extended part (12) is parallel to the tensile top (7).

4. The power battery cover of claim 3, wherein the tensile top (7) is shaped like a rectangle, a circle or an oval.

5. The power battery cover of claim 2, wherein the tensile lateral (8) comprises a first arc (9) and a second extended part (10), the first arc (9) is set as an incurvate semi-circle, the second extended part (10) is connected to the first arc (9), and the second extended part (10) is parallel to the tensile top (7).

6. The power battery cover of claim 5, wherein the tensile top (7) is shaped like a rectangle, a circle or an oval.

7. The power battery cover of claim 2, wherein the tensile lateral (8) comprises a second arc (19) and a first L-shaped block (11), the second arc (19) is set as an incurvate semi-circle, and the first L-shaped block (11) is connected to the second arc (19).

8. The power battery cover of claim 7, wherein the tensile top (7) is shaped like a rectangle, a circle or an oval.

9. The power battery cover of claim 2, wherein the tensile lateral (8) comprises a sunken concave part (14), a raised convex part (15) and a second L-shaped block (13), the concave part (14) is smoothly connected to the convex part (15), and the convex part (15) is connected to the second L-shaped block (13).

10. The power battery cover of claim 9, wherein the tensile top (7) is shaped like a rectangle, a circle or an oval.
